(19) United States
(12) Patent Application Publication
(10) Pub. No.: US 2019/0249791 A1
(43) Pub. Date: Aug. 15, 2019

(54) BACK PRESSURE VALVE HAVING A REDUCED PRESSURE DROP REQUIRED FOR FLUID TO PASS THROUGH THE VALVE

(71) Applicant: Walter R. Chapman, JR., Cleveland Heights, OH (US)

(72) Inventor: Walter R. Chapman, JR., Cleveland Heights, OH (US)

(21) Appl. No.: 15/896,227

(22) Filed: Feb. 14, 2018

(51) Int. Cl. F16K 17/10

(52) U.S. Cl. CPC F16K 17/105

(57) ABSTRACT

A back-pressure valve having a lower internal pressure drop used in conjunction with a compressor. The back-pressure valve includes a valve body with a fluid inlet and a fluid outlet wherein the fluid inlet is disposed at an angle of 90 degrees to the fluid outlet. The valve body includes a self-modulating back pressure valve set to open at a given pressure. The self-modulating back pressure valve includes a valve for moving towards and away from a valve seat to allow fluid flow from the fluid inlet to the fluid outlet when the valve is spaced from the valve seat. The valve seat forms an orifice. The ratio of the area of the orifice to an area of the fluid flow channel from the valve inlet to the valve outlet of the minimum pressure valve reduces the pressure drop required for the fluid to pass thru the valve.

### FIELD OF INVENTION

The present invention relates generally to rotary screw type compressor systems, and, more specifically, the present invention relates to a high efficiency, minimum pressure valve with an integrated independent check valve featuring a lower internal pressure drop.

### BACKGROUND OF INVENTION

Compressors are used in a wide variety of industrial and residential applications. Compressors are also used to inflate or otherwise impart a fluid force on an external object such as tires or pneumatic tools. It is always desirable that a compressor provide consistent and efficient operation to ensure that the particular application (e.g., pneumatic tools) functions properly. To that end, modulation of compressor inlet and outlet conditions can provide reliable and efficient compressor and system operation.

A typical rotary-screw gas compressor operates as follows. Note that all references to gas refers to all gasses i.e. methane, nitrogen, argon, helium, air, etc. Gas is drawn into the compressor by the screw elements through an inlet filter. The inlet filter prevents dirt and dust from entering the compressor with the incoming gas. Preventing the input of dirt and dust protects the screw elements which are very expensive and can be damaged. It's also important to filter the gas as a first step in making sure that the compressed gas is clean: all the dust that is drawn into the gas compressor will eventually end up in the compressed gas system.

Before the gas enters compressor, it passes thru an inlet valve or unloader valve. This valve opens and closes the gas supply to the screw elements. When the inlet valve is open, the compressor is in the ‘loaded’ condition: it is actually compressing gas and pumping it into the compressed gas system. When the inlet valve is closed, it shuts off the gas supply to the compressor elements: the motor and screw elements are turning but the compressor is not drawing any gas in and is not pumping any gas out to the system.

When the inlet/unloader valve is open, the gas enters the compressor and across the screw elements located within the compressor housing. The screw elements work like a pump and compress the gas. During this process, oil is injected into the compressor and surrounds the screw elements. The oil is provided to cool the gas as the gas gets very hot during compression and lubricate the bearings supporting the screw elements. It's also there for sealing off the clearances between the screws elements.

The result is a mixture of compressed gas and compressor oil. This mixture leaves the compressor housing surrounding the screw elements through an exit pipe.

The mixture of compressed gas and oil is directed into a gas/oil separator tank. The oil can be separated from the compressed gas by centrifugal force. The remaining oil (mostly small droplets and oil mist) can be separated from the compressed gas by a separator element which appears to be a big filter.

The gas with oil flows through the separator element. The separator element separates the oil from the compressed gas. The separated oil is collected at the bottom of the separator and is directed back to the compressor housing element. The separated oil is hot and is cooled by an oil cooler. Finally, the oil flows through an oil filter which removes all the dirt and dust that has collected in the oil. The oil is now again injected into the housing with the screw elements.

The now clean compressed gas is almost ready to leave the compressor system. But first, it is passed through a minimum pressure valve with independent check valve preventing any back flow of the gas.

The minimum pressure valve is typically a spring-loaded valve that opens at a certain pressure, for example 4 bar. The minimum pressure valve ensures that there is always a minimum pressure inside the gas/oil separator. This minimum pressure is needed for the correct operation of the compressor (i.e., pumping the oil around).

The compressed gas is still very hot at this point, about 80 degrees Celsius. The compressed gas is sometimes cooled by an after cooler before it leaves for its intended use. The gas temperature after the cooler is about 25-40 degrees Celsius.

Because of the cooling down of the gas, a lot of water vapor condenses against the inside of the after cooler. This water is carried with the compressed gas towards the outlet of the compressor system. For this reason, a water or condensate trap separates the water from the compressed gas. The water is drained away through a small hose.

The compressed gas now finally leaves the compressor system.

### SUMMARY OF THE INVENTION

According to the present invention, a back-pressure valve having a lower internal pressure drop used in conjunction with a compressor. The back-pressure valve includes a valve body with a fluid inlet and a fluid outlet. The valve body has a 90-degree design wherein the fluid inlet is disposed at an angle of 90 degrees to the fluid outlet. The valve body includes a self-modulating, back pressure valve with an independent check valve set to open at a given pressure. The self-modulating, back pressure valve includes an independent, poppet style check valve for moving towards and away from a valve seat to allow fluid flow from the fluid inlet to the fluid outlet when the valve is spaced from the valve seat. The valve seat forms an orifice (diameter B). The ratio of the area of the orifice to an area of the fluid outlet is 1.1, the ratio of a length of a first radius line A from a center of the orifice to a back body wall of the valve body opposite the fluid outlet to the diameter B of the orifice is 0.604, the ratio of a length of a radius line C to the diameter B of the orifice where radius line C extends from the center of the orifice to the back wall of the valve body and where the radius line C is disposed at an angle X of 45 degrees to the radius line A is 0.745, the ratio of the length of a radius line D to the diameter B of the orifice where radius line D extends from the center of the orifice to a side wall of the valve body and where the radius line D is disposed at an angle Y of 90 degrees to the radius line A is 0.847, the ratio of the length of a radius line E to the diameter B of the orifice where radius line E extends from the center of the orifice to the side wall of the valve body and where the radius line E is disposed at an angle Z of 135 degrees to the radius line A is 0.88, and the ratio of the length of a radius line F to the diameter B of the orifice where radius line F extends from the center of the orifice to the outlet and where the radius line F is disposed at an angle W of 180 degrees to the radius line A is equal to or greater than 1.25 whereby the minimum pressure valve reduces the pressure drop required for the fluid to pass thru the pressure valve.

According to the present invention, a rotary-screw type, compressor system includes a gas inlet conduit through which gas is drawn through and directed into a compressor. A mixture of compressed gas and compressor oil is directed from the compressor to an exit conduit. The mixture of compressed gas and oil is directed through the exit conduit into a gas/oil separator tank in which the compressor oil can be separated from the compressed gas. An oil return conduit directs oil separated from the compressed gas back to the compressor. An exhaust conduit directs the compressed gas from the gas/oil separator into minimum pressure valve with an independent check valve so that there is always a minimum pressure inside the gas/oil separator. The minimum pressure valve comprises a valve body with a fluid inlet and a fluid outlet, the valve body having a 90-degree design wherein the fluid inlet is disposed at an angle of 90 degrees to the fluid outlet. The valve body includes a self-modulating back pressure valve with an independent check valve set to open at a given pressure. The self-modulating back pressure valve includes a valve (the poppet style check valve) for moving towards and away from a valve seat to allow fluid flow from the fluid inlet to the fluid outlet when the valve is spaced from the valve seat. The valve seat forms an orifice. The ratio of the area of the orifice to the area of the fluid outlet is 1.1+/−0.05, the ratio of a length of a first radius line A from a center of the orifice to a back body wall of the valve body opposite the fluid outlet to the diameter B of the orifice is 0.604+/−0.03, the ratio of a length of a radius line C to the diameter B of the orifice where radius line C extends from the center of the orifice to the back wall of the valve body and where the radius line C is disposed at an angle X of 45 degrees to the radius line A is 0.745+/−0.037, the ratio of the length of a radius line D to the diameter B of the orifice where radius line D extends from the center of the orifice to a side wall of the valve body and where the radius line D is disposed at an angle Y of 90 degrees to the radius line A is 0.847+/−0.042, the ratio of the length of a radius line E to the diameter B of the orifice where radius line E extends from the center of the orifice to the side wall of the valve body and where the radius line E is disposed at an angle Z of 135 degrees to the radius line A is 0.88+/−0.047 and the ratio of the length of a radius line F to the diameter B of the orifice where radius line F extends from the center of the orifice to the outlet and where the radius line F is disposed at an angle W of 180 degrees to the radius line A is equal to or greater than 1.25 whereby the minimum pressure valve reduces the pressure drop required for the fluid to pass thru the valve.

### BRIEF DESCRIPTION OF THE DRAWINGS

The structure, operation, and advantages of the present invention will become further apparent upon consideration of the following description taken in conjunction with the accompanying figures (Figures). The figures are intended to be illustrative, not limiting.

Certain elements in some of the figures may be omitted, or illustrated not-to-scale, for illustrative clarity. The cross-sectional views may be in the form of slices, or near-sighted cross-sectional views, omitting certain background lines which would otherwise be visible in a true cross-sectional view, for illustrative clarity.

Often, similar elements may be referred to by similar numbers in various figures (Figures) of the drawing, in which case typically the last two significant digits may be the same, the most significant digit being the number of the drawing figure (Figure).

FIG. 1 is a schematic line diagram of the location of a modulating back pressure valve with a poppet style check valve in relation to other systems it is intended for use in conjunction with, according to the present invention.

FIG. 2 is a three-dimensional view of the modulating back pressure valve with a poppet style check valve, according to the present invention.

FIG. 3 is a front view of the modulating back pressure valve with a poppet style check valve, according to the present invention.

FIG. 4 is a side view of the modulating back pressure valve with a poppet style check valve shown in FIG. 3, according to the present invention.

FIG. 5 is an orthogonal cross-sectional side view through line 5-5 of the modulating back pressure valve with a poppet style check valve, shown in FIG. 4, in a closed position, according to the present invention.

FIG. 6 is an orthogonal cross-sectional view side view through line 5-5 of the modulating back pressure valve with a poppet style check valve, shown in FIG. 3, in an open position, according to the present invention.

FIG. 7 is an orthogonal cross-sectional view side view through line 5-5 of the modulating back pressure valve with a poppet style check valve, shown in FIG. 3, with the poppet valve in a closed position while the back-pressure valve is in the open position, according to the present invention.

FIG. 8 is an orthogonal cross-sectional side view through line 8-8 of the modulating back pressure valve with a poppet style check valve, shown in FIG. 4, in an open position, according to the present invention.

### DETAILED DESCRIPTION OF THE PREFERRED EMBODIMENT

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

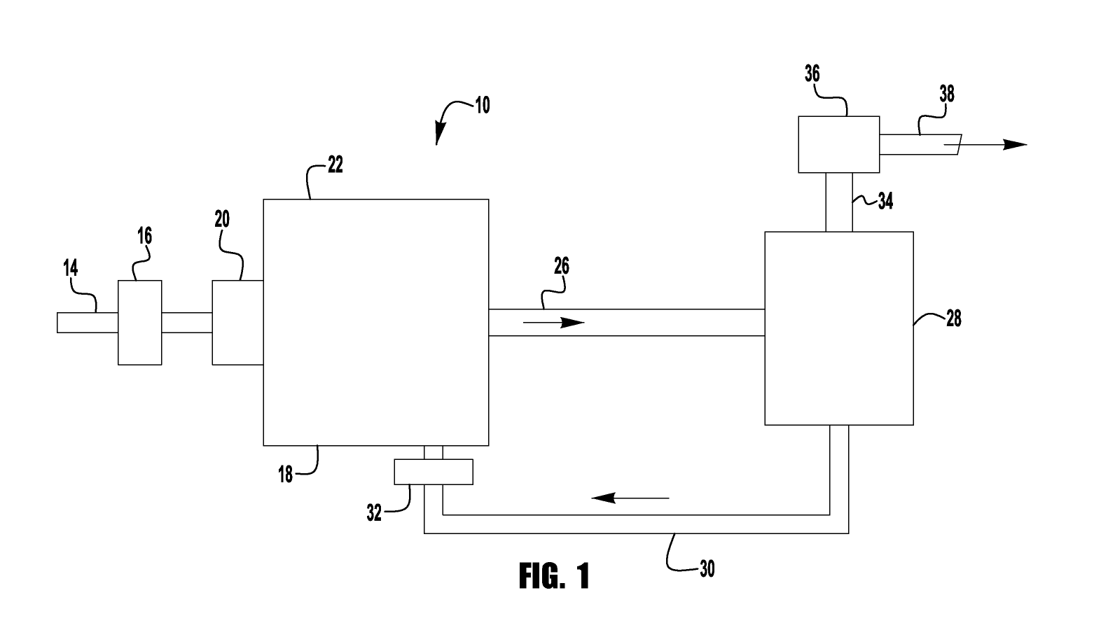

Referring to FIG. 1, there is illustrated a typical rotary-screw type, compressor system 10 incorporating an improved minimum pressure valve 36, according to the present invention.

The rotary-screw type, compressor system 10 includes an inlet conduit 14 through which gas is drawn through and directed into compressor 18 housing screw elements (not shown). An inlet filter 16 disposed in the inlet conduit 14 is provided to prevent dirt and dust from entering the compressor 18 with the incoming gas. Preventing the input of dirt and dust into the compressor 18 protects the screw elements which are very expensive and can be damaged. It's also important to filter the gas as a first step in making sure that the compressed gas is clean because all the dirt and dust that is drawn into the compressor 18 will eventually end up in the compressed gas system.

Before the gas enters the compressor 18, it passes through an inlet or unloader valve 20. The unloader valve 20 opens and closes the inlet conduit 14 and thereby regulates the gas supply to the screw elements in the compressor 18. When the inlet valve 20 is open, the compressor 18 is in the ‘loaded’ condition during which it is actually compressing gas and pumping it through the compressed gas system 10. When the inlet valve 20 is closed, it shuts off the gas supply to the compressor screw elements. That is, the motor and screw elements (not shown) are turning but the compressor 18 is not drawing any gas in through the inlet conduit 14 and is not pumping any compressed gas out of the system 10.

When the inlet valve 20 is open, the gas enters the compressor 18 and flows across the screw elements located within the compressor housing 22. The screw elements work as a pump and compress the gas. During this process, oil is injected into the compressor housing 22 and surrounds the screw elements. The oil is provided to cool the gas which gets very hot during compression. The oil is also there for lubrication of bearings and sealing off the clearances between the screws elements.

The result is a mixture of compressed gas and compressor oil, i.e. oily outlet gas, leaving the compressor housing 22 surrounding the screw elements through exit conduit 26.

The mixture of compressed gas and oil is directed through the exit conduit 26 into a gas/oil separator tank 28. The oil can be separated from the compressed gas by means, such as centrifugal force. The separated oil is collected at the bottom of the gas/oil separator 28 and is directed back to the compressor 18 through an oil return conduit 30. The separated oil is hot and can be cooled by an oil cooler 32 in return conduit 30. Finally, the oil flows through an oil filter (not shown) which removes all the dirt and dust that has collected in the oil. The oil is now again injected into the compressor housing 22 with the screw elements.

The clean, compressed gas is directed from the gas/oil separator 28 through an exhaust conduit 34 and through a minimum pressure valve 36. The minimum pressure valve 36 has an independent one-way valve 46 (i.e. check valve) preventing gas from flowing back into the gas/oil separator and compressor system 10.

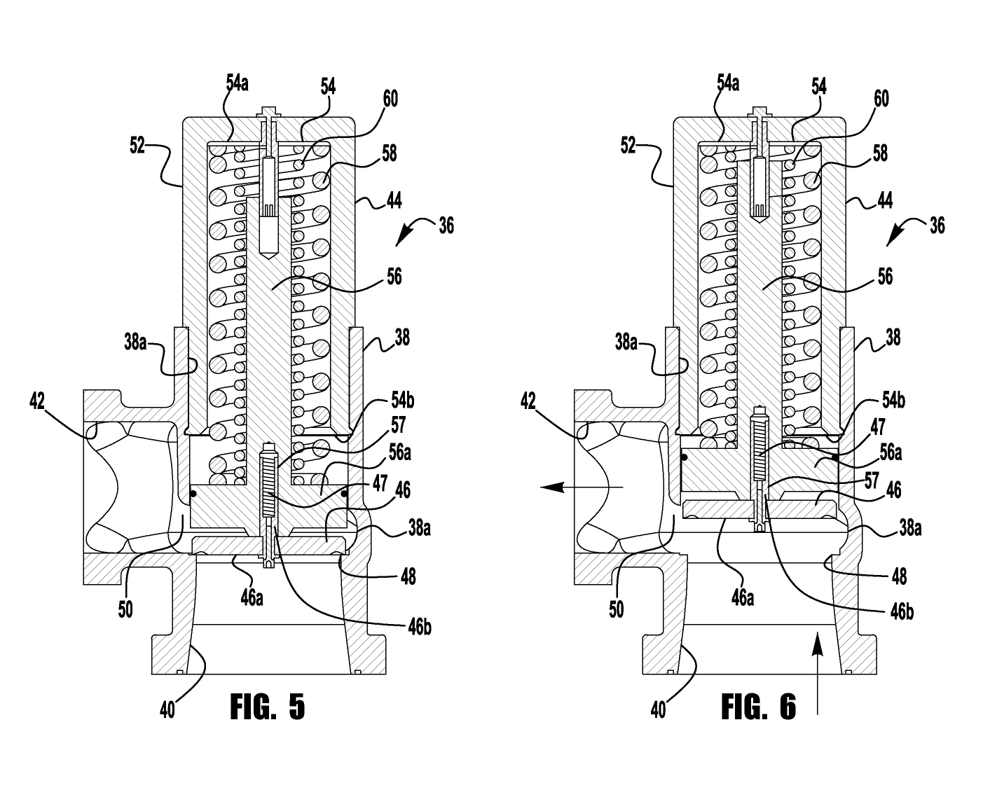

The minimum pressure valve 36 is typically a spring-loaded, self-modulating back-pressure valve with an independent check valve, as shown in FIG. 5, that opens at a certain pressure, such as about 4 bar. The minimum pressure valve 36 ensures that there is always a minimum pressure inside the gas/oil separator 28. This minimum pressure is needed for the proper operation of the compressor 18, such as for pumping the oil around within the compressor housing 22. The compressed gas is still very hot at this point, about 80 degrees Celsius, and may be directed through an after cooler (not shown) to reduce the gas temperature from about 25 degrees to about 40 degrees Celsius. The compressed gas now passes through a conduit 38 to a desired location.

An important aspect of the present invention relates to increasing the efficiency and energy conservation by providing a lower internal pressure drop in the minimum pressure valve 36 as compared with prior art minimum valves used in conjunction with a rotary screw compressor. The back-pressure valve 56 opens at a defined pressure and allows fluid to flow out of the compressor system 10. If the pressure in air/oil separator 28 decreases below a preset pressure, the back-pressure valve 56 closes. In the case of an oil flooded, rotary screw compressor, the high pressure allows oil to stay within the screws and supply's lubrication to the bearings. Once the back-pressure valve 56 opens, fluid, i.e., high pressure gas flowing through the minimum pressure valve, experiences a loss in pressure. The present invention provides a design for a minimum pressure valve 36 which significantly reduces the pressure drop required for the fluid to pass thru the valve.

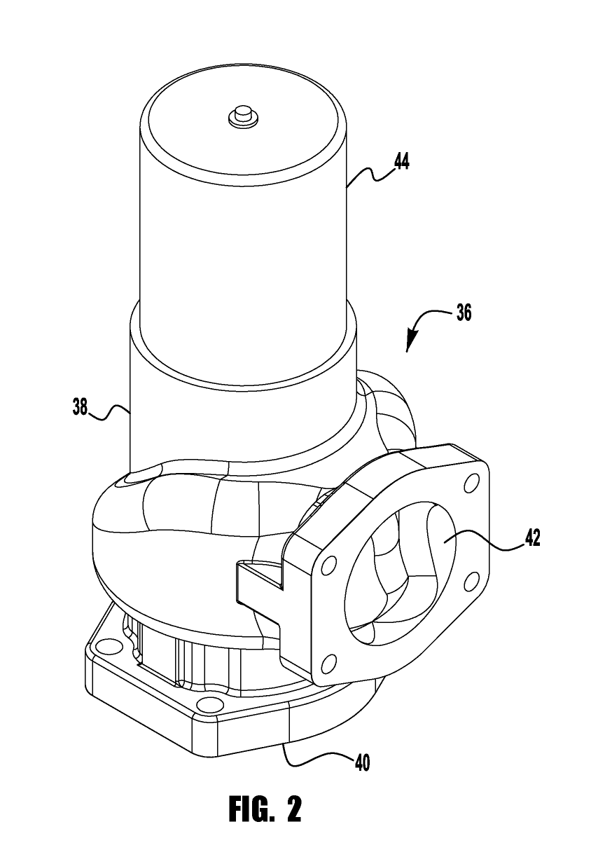

The minimum pressure valve 36, as shown in FIGS. 2-7, has a valve body 38 with a fluid inlet 40 and a fluid outlet 42. The minimum pressure valve 36 has a 90-degree design wherein the fluid inlet 40 is disposed at an angle of 90-degrees to the fluid outlet 42. The pressure drop through the minimum pressure valve 36 is lowered by having a smoothly accelerating, fluid velocity within the valve and by shaping the valve body 38 to turn and smoothly accelerate the fluid an angle of 90 degrees from the fluid inlet 40 to the fluid outlet 42.

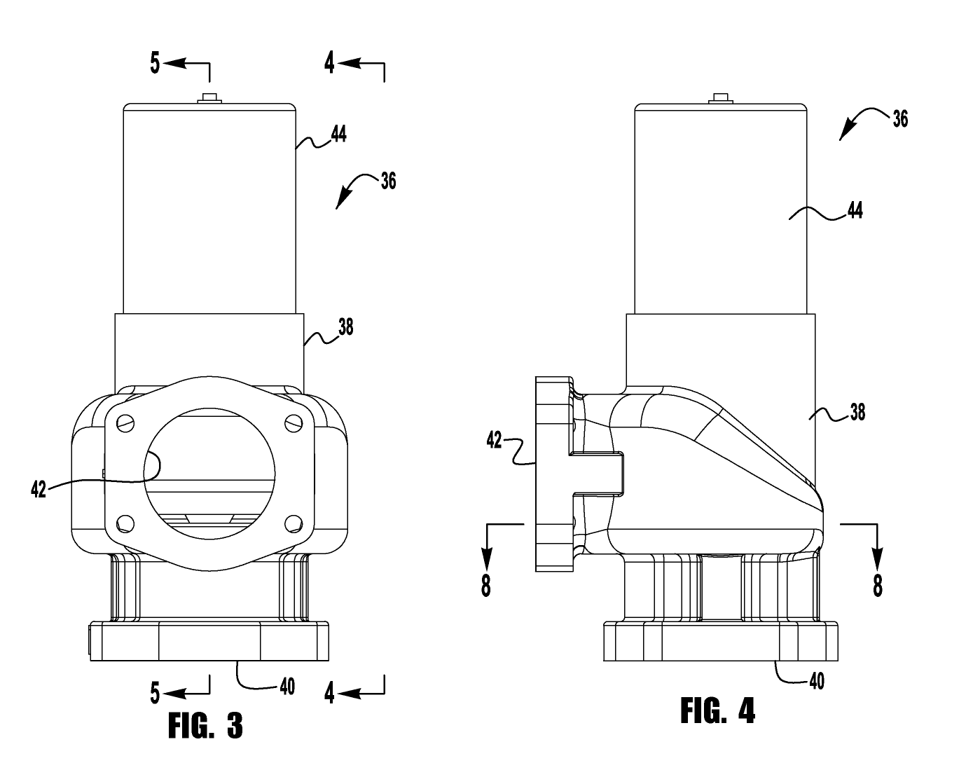

As shown in FIGS. 5-7, the valve body 38 incorporates a poppet style, check valve 46 and a back-pressure valve 56 set to open at a given pressure. The back-pressure valve 56, according to the present invention, is self-modulating in a way that becomes evident upon contemplation of the orthogonal, cross-sectional, view of the modulating back pressure valve 56 in FIG. 5, through the section 5-5 indicated in FIG. 3. In FIG. 5, a poppet style check valve 46 is shown in a closed position against the valve seat 48. In this condition, the gas pressure of the gas flowing through exit conduit 26 from the compressor 22 is insufficient to move an actuator piston 56a in a direction away from the valve seat 48 causing the poppet valve 46 to be closed against the valve seat. In this state, gas would not flow though the fluid inlet 40. Alternatively, if the gas pressure of the gas flowing through exit conduit 26 from the compressor 22 is sufficient to move the actuator piston 56a in a direction away from the valve seat 48, the poppet valve 46 would initially be positioned away from valve seat 48 as shown in FIG. 6. In that case, poppet valve 46 would be open and the high pressure gas would flow, as shown by the arrows, through the fluid inlet 40 from an exhaust conduit 26, across the valve seat 48, through intermediate section 50 of the valve body 38, out of fluid outlet 42 and through a fluid conduit 38 to a device or system (not shown) which requires compressed gas. Note that the poppet valve 46 would only be in the open position shown in FIG. 6 when the device connected to the conduit 38 is using the compressed gas. However, when the device connected to the conduit 38 is not using the compressed gas at inlet 40 having a pressure sufficient to move the actuator piston 56a in a direction away from the valve seat 48, the poppet valve 46 would be biased by spring 47 to a closed position against the valve seat 48.

Referring again to FIG. 5, there is illustrated a cross sectional view of the actuator section 52 of the modulating back pressure valve 56. The actuator section 52 includes a cylinder 54 closed at one end 54a and open at an opposite end 54b. The cylinder 54 is disposed in a cylindrical section 38a of the valve body 38 which is aligned with the fluid inlet 40. The cylindrical section 38a extends towards the fluid inlet 40 and partially closes the fluid outlet 42, as shown in FIG. 5. An actuator piston 56a is disposed in the cylinder 54 and has a circular, piston shaped end 56a which moves back and forth within the cylindrical section 38a. An independent poppet style check valve 46 is guided by a cylindrical rod 46b disposed within a cavity 57 located in the circular shaped end 56 and is biased outward and away from the piston 56a by a spring 47 disposed in the cavity 57.

When there is not enough gas pressure generated by the compressor 22, there is no gas flow from fluid inlet 40 to fluid outlet 42 and check valve 46 remains seated on the valve seat 48. This occurs because the two compression springs 58 and 60 that are disposed in the cylinder 54 around the back-pressure valve 56, bias the piston end 56a and the poppet valve 46 towards the valve seat 48.

Even when there is enough pressure generated by the compressor 22 to move the circular, piston shaped end 56a away from valve seat 48, the poppet style check valve 46 can still be seated or unseated from the valve seat 48. When, for example, the device receiving pressurized gas from line 38 is using the pressurized gas, there is gas flow from the fluid inlet 40 to the fluid outlet 42 and the check valve 46 is spaced from the valve seat 48.

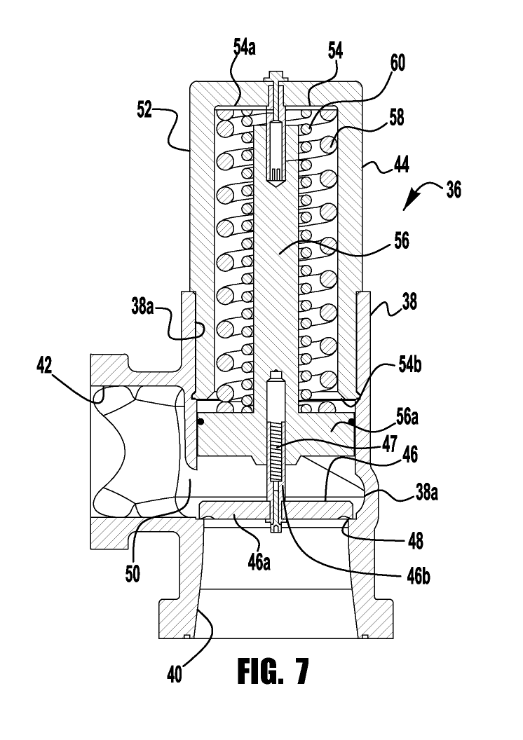

As shown in FIGS. 6 and 7, when the high-pressure gas in exhaust conduit 26 is above a predetermined value, the gas acts against the face 46a of the poppet style check valve 46 so as to push the poppet style check valve against the bias of spring 47 and compression springs 58 and 60 to force the check valve 46 away from the valve seat 48 whereby pressurized gas will flow from the fluid inlet 40 to the fluid outlet 42. Conversely, when the high-pressure gas in exhaust conduit 26 is below a predetermined value, the bias of compression springs 58 and 60 will force the poppet style check valve 46 against the valve seat 48 whereby pressurized gas will unable to flow from the fluid inlet 40 to the fluid outlet 42.

As discussed hereinbefore, the poppet valve 46 would only be in the open position as shown in FIG. 6 when the device connected to the conduit 38 is using the compressed gas. However, when the device connected to the conduit 38 is not using the compressed gas, and there is still sufficient pressure generated by the compressor 22 to move the actuator piston 56a in a direction away from the valve seat 48, the poppet style check valve 46 would be biased by spring 47 to a closed position against the valve seat 48, as shown in FIG. 7, whereby pressurized gas will not flow from the fluid outlet 42 to the fluid inlet 40.

The fluid inlet 40, the orifice 48 and the fluid exit 42 are designed so that a smoothly increasing fluid speed is maintained. The body is designed so that the follow ratios within the valve are maintained within the tolerance.

As discussed hereinbefore, the minimum pressure valve 36 having a valve body 38 with a fluid inlet 40 and a fluid outlet 42. The minimum pressure valve 36 has a 90-degree design wherein the fluid inlet 40 is disposed at an angle of 90 degrees to the fluid outlet 42. The pressure drop through the minimum pressure valve 36 is lowered by having a smoothly accelerating, fluid velocity within the pressure valve and by shaping the valve body 38 to turn and smoothly accelerate the fluid an angle of 90 degrees from the fluid inlet 40 to the fluid outlet 42.

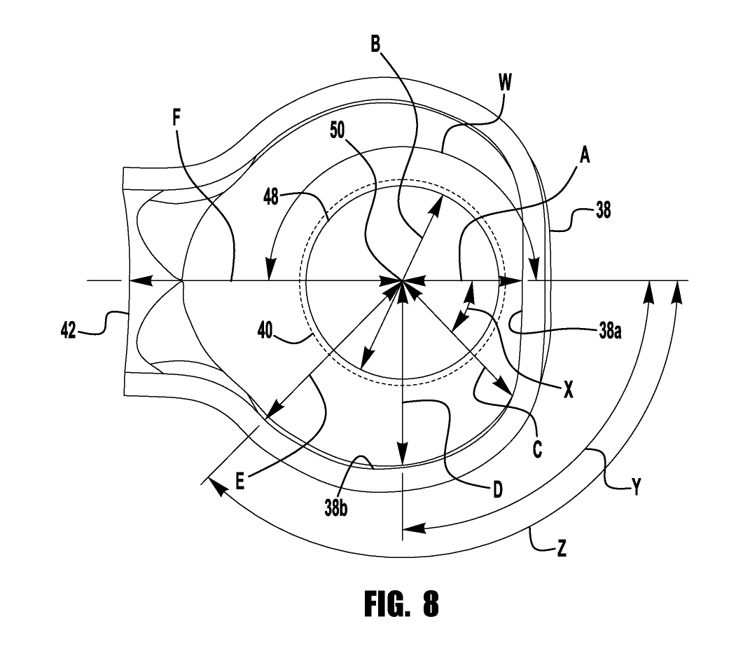

Referring to FIG. 8 there is illustrated a view through 8-8 of FIG. 4 with which the preferred construction can be understood. The modulating back pressure valve 56 incorporates a valve body 38 designed so that the following ratios are maintained within the specified tolerance.

Referring to FIG. 8, the area of the fluid inlet 40 is larger than the area of the orifice 48.

The ratio of the area of the orifice 48 to the area of the fluid outlet 42 is 1.1+/−0.05.

Area_{Orifice}/Area_{Fluid Outlet}=1.1+/−0.05

The ratio of the length of radius line A from the center 50 of the orifice 48 to the back body wall 38a (opposite the fluid outlet 42) to the diameter B of the orifice 48 is 0.604+/−0.03.

length_{A}/diameter_{B}=0.604+/−0.03

The ratio of the length of radius line C to the diameter line B of the orifice 48 where radius line C extends from the center 50 of the orifice 48 to the back wall 38a and where the radius line C is disposed at an angle X of 45 degrees to the radius line A is 0.745+/−0.037.

length_{C}/diameter_{B}=0.745+/−0.037

The ratio of the length of a radius line D to the diameter B of the orifice 48 where the radius line D extends from the center 50 of the orifice 48 to the side wall 38b and where the radius line D is disposed at an angle Y of 90 degrees to the radius line A is 0.847+/−0.042.

length_{D}/diameter_{B}=0.847+/−0.042

The ratio of the length of a radius line E to the diameter B of the orifice 48 where radius line E extends from the center 50 of the orifice 48 to the side wall 38b and where the line E is disposed at an angle Z of 135 degrees to the line A is 0.88+/−0.047.

length_{E}/diameter_{B}=0.88+/−0.047

The ratio of the length of a radius line F to the diameter B of the orifice 48, where the radius line F extends from the center 50 of the orifice 48 to the outlet 42 and where the radius line F is disposed at an angle W of 180 degrees to the radius line A, is equal to or greater than 1.25.

length_{F}/diameter_{B}=is equal to or greater than 1.25

In a typical example, the inlet pressure at the fluid inlet 40 is 100 pounds per square inch (psi) (6.895 bar) at the design flow and 99.6 psi (6.867 bar) at the fluid outlet 42. Previously, in a pressure valve similar to pressure valve 36 but without the shape defined by the ratios described hereinbefore, the outlet pressure was 99 psi (6.826 bar). Therefore, there is an increased pressure which is used to operate a high-pres sure device downstream from the fluid outlet 42. With an increase in the outlet pressure at the fluid outlet 42 corresponding to a 60% improvement in pressure drop, the compressor system 10 can operate more efficiently.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A back pressure valve having a lower internal pressure drop used in conjunction with a gas compressor, comprising:
a valve body with a fluid inlet and a fluid outlet, the valve body having a 90 degree design wherein the fluid inlet is disposed at an angle of 90 degrees to the fluid outlet;
the valve body including a self-modulating back pressure valve set to open at a given pressure;
the self-modulating back pressure valve includes a check valve for moving towards and away from a valve seat to allow fluid flow from the fluid inlet to the fluid outlet when the check valve is spaced from the valve seat;
the valve seat forms an orifice;
the ratio of the area of the orifice to an area of the fluid outlet is 1.1;
the ratio of a length of a first radius line A from a center of the orifice to a back wall of the valve body opposite the fluid outlet to the diameter B of the orifice is 0.604;
the ratio of a length of a radius line C to the diameter B of the orifice where radius line C extends from the center of the orifice to the back wall of the valve body and where the radius line C is disposed at an angle X of 45 degrees to the radius line A is 0.745;
the ratio of the length of a radius line D to the diameter B of the orifice where radius line D extends from the center of the orifice to a side wall of the valve body and where the radius line D is disposed at an angle Y of 90 degrees to the radius line A is 0.847;
the ratio of the length of a radius line E to the diameter B of the orifice where radius line E extends from the center of the orifice to the side wall of the valve body and where the radius line E is disposed at an angle Z of 135 degrees to the radius line A is 0.88; and
the ratio of the length of a radius line F to the diameter B of the orifice where radius line F extends from the center of the orifice to the outlet and where the radius line F is disposed at an angle W of 180 degrees to the radius line A is equal to or greater than 1.25 whereby the minimum pressure valve reduces the pressure drop required for the fluid to pass thru the pressure valve.

2. The back-pressure valve of claim 1 wherein the ratio of the area of the orifice to an area of the fluid outlet is 1.1+/−0.05.

3. The back-pressure valve of claim 1 wherein the ratio of a length of a first radius line A from a center of the orifice to a back wall of the valve body opposite the fluid outlet to the diameter B of the orifice is 0.604+/−0.03.

4. The back-pressure valve of claim 1 wherein the ratio of a length of a radius line C to the diameter B of the orifice where radius line C extends from the center of the orifice to the back wall of the valve body and where the radius line C is disposed at an angle X of 45 degrees to the radius line A is 0.745+/−0.037.

5. The back-pressure valve of claim 1 wherein the ratio of the length of a radius line D to the diameter B of the orifice where radius line D extends from the center of the orifice to a side wall of the valve body and where the radius line D is disposed at an angle Y of 90 degrees to the radius line A is 0.847+/−0.042.

6. The back-pressure valve of claim 1 wherein the ratio of the length of a radius line E to the diameter B of the orifice where radius line E extends from the center of the orifice to the side wall of the valve body and where the radius line E is disposed at an angle Z of 135 degrees to the radius line A is 0.88+/−0.049.

7. The back-pressure valve of claim 1 wherein:
the self-modulating back pressure valve has an actuator section consisting of a cylinder closed at one end and open at an opposite end; and
the cylinder being disposed in a cylindrical section of the valve body which is aligned with the fluid inlet.

8. The back-pressure valve of claim 7 wherein:
an actuator disposed in the cylinder has a circular piston shaped end which moves back and forth within the cylindrical section.

9. The back-pressure valve of claim 8 wherein at least one compression spring is disposed in the cylinder in contact with the actuator piston to bias the valve into a closed position against the valve seat.

10. The back-pressure valve of claim 9 wherein two compression spring is disposed in the cylinder in contact with the actuator piston to bias the valve into a closed position against the valve seat.

11. The back-pressure valve of claim 8 wherein:
the check valve is a poppet style check valve guided by a cylindrical rod disposed within a cavity located in the circular shaped end and biased outward and away from the piston shaped end by a spring disposed in the cavity.

12. The back-pressure valve of claim 8 wherein when the high pressure gas in exhaust conduit is above a predetermined value, the gas acts against the face of the valve so as to push the valve against the bias of at least one compression spring to force the valve away from the valve seat whereby pressurized gas will flow from the fluid inlet to the fluid outlet.

13. The back-pressure valve of claim 8 wherein when the pressure from the output side of the compressor is below a certain predetermined value, the bias of compression springs will force the valve against the valve seat whereby pressurized gas will not be able to flow from the fluid inlet to the fluid outlet.

14. The back-pressure valve of claim 6 wherein the fluid inlet, the orifice and the fluid exit are designed so that a smoothly increasing fluid speed is maintained.

15. A rotary-screw type, compressor system including:
a gas inlet conduit through which gas is drawn through and directed into a compressor containing oil to cool the gas during compression;
a mixture of compressed gas and compressor oil being directed from the compressor through an exit conduit and into a gas/oil separator tank in which the compressor oil can be separated from the compressed gas;
an oil return conduit for directing the compressor oil separated from the compressed gas back to the compressor;
an exhaust conduit directing the compressed gas from the gas/oil separator into a self-modulating back pressure valve that maintains a minimum pressure inside the gas/oil separator;
the self-modulating back pressure valve comprises:
a valve body with a fluid inlet and a fluid outlet, the valve body having a 90 degree design wherein the fluid inlet is disposed at an angle of 90 degrees to the fluid outlet;
the valve body including a poppet style check valve set to open at a given pressure;
the poppet style check valve moving towards and away from a valve seat to allow fluid flow from the fluid inlet to the fluid outlet when the poppet style check valve is spaced from the valve seat;
the valve seat forms an orifice;
the ratio of the area of the orifice to an area of the fluid outlet is 1.1+/−0.05;
the ratio of a length of a first radius line A from a center of the orifice to a back wall of the valve body opposite the fluid outlet to the diameter B of the orifice is 0.604+/−0.03;
the ratio of a length of a radius line C to the diameter B of the orifice where radius line C extends from the center of the orifice to the back wall of the valve body and where the radius line C is disposed at an angle X of 45 degrees to the radius line A is 0.745+/−0.037;
the ratio of the length of a radius line D to the diameter B of the orifice where radius line D extends from the center of the orifice to a side wall of the valve body and where the radius line D is disposed at an angle Y of 90 degrees to the radius line A is 0.847+/−0.042;
the ratio of the length of a radius line E to the diameter B of the orifice where radius line E extends from the center of the orifice to the side wall of the valve body and where the radius line E is disposed at an angle Z of 135 degrees to the radius line A is 0.88+/−0.047; and
the ratio of the length of a radius line F to the diameter B of the orifice where radius line F extends from the center of the orifice to the outlet and where the radius line F is disposed at an angle W of 180 degrees to the radius line A is equal to or greater than 1.25 whereby the minimum pressure valve reduces the pressure drop required for the fluid to pass thru the pressure valve.

16. The back-pressure valve of claim 15 wherein:
the self-modulating back pressure valve has an actuator section consisting of a cylinder closed at one end and open at an opposite end; and
the cylinder being disposed in a cylindrical section of the valve body which is aligned with the fluid inlet.

17. The back-pressure valve of claim 16 wherein:
an actuator disposed in the cylinder has a circular piston shaped end which moves back and forth within the cylindrical section of the valve body.

18. The back-pressure valve of claim 17 wherein at least one compression spring is disposed in the cylinder in contact with the actuator piston to bias the valve into a closed position against the valve seat.

19. The back-pressure valve of claim 18 wherein two compression springs are disposed in the cylinder in contact with the actuator piston.

20. The back-pressure valve of claim 17 wherein when the high pressure gas in exhaust conduit is above a predetermined value, the gas acts against the face of the valve so as to push the valve against the bias of at least one compression spring to force the valve away from the valve seat whereby pressurized gas will flow from the fluid inlet to the fluid outlet.
